(19) United States
(12) Patent Application Publication
(10) Pub. No.: US 2008/0144575 A1
(43) Pub. Date: Jun. 19, 2008

(54) Method and Apparatus for VoIP WiFi Phone Application

(76) Inventors: Michael Chen, Palos Verses Estates, CA (US); Sheng-Wang Hsieh, Tai-Chang (TW); Arthur Chung-Shu Ten, Hsin-Chu (TW); Cary Lee-Yuang Huang, Hsin-chu (TW)

Correspondence Address: LAW OFFICES OF LAI AND ASSOCIATES, P.C., 5800 RANCHESTER STE 200, HOUSTON, TX, 77036, US

(21) Appl. No.: 11/611,417

(22) Filed: Dec. 15, 2006

(51) Int. Cl. H04Q 7/00

(52) U.S. Cl. 370/331

(57) ABSTRACT

A base station comprises a radio port cluster and a switch/router. Instead of passively following the order from a client terminal, the WiFi base station plays the major role in a hand-over process. The base station will monitor the client terminal signal strength and negotiate with other base stations for the client terminal connection including authentication and authorization. When the client terminal's signal strength is changing, the base station will send out a request to other base stations to report signal strength and trend of this particular client terminal. Based on reported signal strength and trend, a determination is made as to which of the other base stations should take over the servicing of the client terminal. The authentication is then forwarded to this base station.

### FIELD OF THE INVENTION

The present invention relates generally to a VoIP WiFi communications system, more specifically, the present invention relates to a high speed hand-over WiFi base-station for VoIP WiFi phone applications.

### BACKGROUND

Mobility for WiFi network is desirous. However, WiFi 802.11 is initially designed for the purpose of Internet wireless connection such that individual can wirelessly obtain and transmit data and information through Internet network. The client terminal has the most active role in this system. Broadband and private/individual application are the key initial requirements while mobility and real time considerations are secondary. The basic WiFi network has at least one AP (Access Point) and a group of client terminals. Client terminals can be devices such as PC (personal computer, PDA (personal digital assistant), etc. Client terminals typically have a WiFi radio module built therein.

Coupled with the popularity of WiFi phones, mobility or the movement of the phone is part of their usage. However, with the existing WiFi network, the drawbacks or the inherent nature of the network include: the client terminal typically has the most active role in the communications context, in that it initiates virtually most of activities involved in the communication. For example; the client terminal locates the available APs, selects the desired AP, and initiates the authentication, as well as define its application. The list goes on. On the other hand, an AP (Access Point) typically passively follows the order from the client terminal with routing function. The above set up generally can satisfy the requirements of Hot-Spot and indoor office/SoHo applications which are mainly for broadband Internet data transmission. But for VoIP WiFi phone (voice) and multi-media with video applications, real time and mobility requirements are major requirements. As such, incorporating VoIP WiFi phone into the WiFi system poses significant QoS (quality of service) issues.

For a currently known basic WiFi network, when the client terminal is moving, the connected AP need to hand-over the connection to another AP. The switch-on (hand-over) time from one AP to another AP will normally need between or more than 1˜2 seconds, thereby making voice with mobility application impossible. The impossibilities are manifested in that phone connection will break. For WiFi wireless city applications or enterprise applications, the minimum mobility speed may be up to 60 km/hr such as for city driving or a moving bus, the speeds are usually up to 60 km/hr. Plus due to the availability of dual mode WiFi/cellular phones, the cellular part can handle high way or country side driving of more than 60 and up to 120 km/hr speed. On the other hand, the WiFi part has room for improvement.

With regard to mobility, there are difficulties for existing, basic WiFi networks in that the provisioning of high voice quality for VoIP WiFi phone application with mobility leave to lot to be desired. Typical the normal flow of switching APs are as follows: a client connects to AP1; when the client starts moving, the signal is getting weak; the client waits for a beacon from AP2 which produces a beacon, typically every second (per sec). The client in turn creates link to AP2 including authentication, authorization, and updating routing table; flow from the client to AP2 starts. As such, time consumed is significant at beacon waiting, authentication & authorization, routing table updating. Furthermore, the hand-over is lengthy, it usually takes more than 1˜2 sec, thereby making voice application virtually impossible.

Several known attempts are made to remedy the above in that improvements of the hand-over speed having better voice mobility are proposed. Mesh Hot Spot had developed something for better data connection mobility. But for real time voice and video requirements, the quality is still poor. Further, adding more hand-over process and improving the efficiency to speed up the switch-on between the APs have been developed. The best moving speed achieved is 10 km/hr; for example; see Meru's network.

In addition, IEEE standard 802.11r is trying to add more QoS functions to both AP and also client terminal WiFi radio module. The target for AP switch-over time is 50 ms for seamless hand-over. More functions are added to the client terminal; for example, client terminal needs to search the neighboring APs and starts the connection while still being connected to the current AP. Dual transceiver may need. The IEEE standard 802.11r is going to have a major impact on WiFi module, but is still under development therefore with uncertainty.

As can be seen, there is a need to have a desirous, high speed hand-over WiFi base-station for VoIP WiFi phone application.

### SUMMARY OF THE INVENTION

At least one high speed hand-over WiFi base-station having inter-communication capabilities for a VoIP WiFi phone application is provided.

In a VoIP WiFi communications system, a high speed hand-over WiFi base station is provided.

In a VoIP WiFi communications system, a switching of the connection to another base station is first achieved before cut off of the current connection.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a WiFi Base Station in accordance with some embodiments of the invention.

FIG. 2 is an example of a high speed VoIP WiFi network hierarchy in accordance with some embodiments of the invention.

FIG. 3 is an example of a hand-over is between the RPs within same base station in accordance with some embodiments of the invention.

FIG. 4 is an example of a hand-over between different base stations in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to high speed hand-over WiFi base-stations having intercommunication capabilities for a VoIP WiFi phone application. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of high speed hand-over WiFi base-stations having intercommunication capabilities for a VoIP WiFi phone application described herein. The non-processor circuits may include, but are not limited to, a radio receiver, a radio transmitter, signal drivers, clock circuits, power source circuits, and user input devices. As such, these functions may be interpreted as steps of a method to perform hand-over in high speed WiFi base-stations having intercommunication capabilities for a VoIP WiFi phone application. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

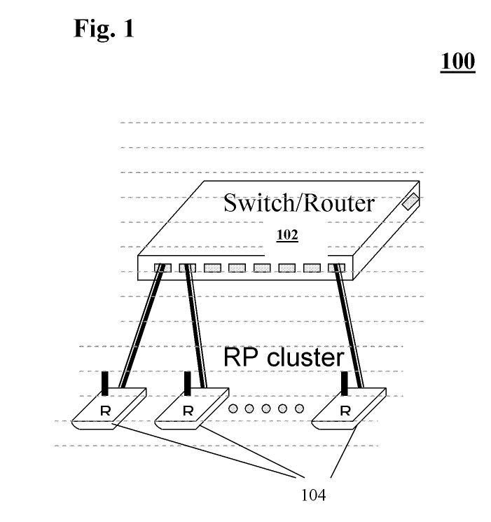

Referring to FIGS. 1-4, a high speed hand-over WiFi base-station 100 having intercommunication capabilities for a VoIP WiFi phone application comprises a Switch/Router 102, and a plurality of RP 104. The connection from a RP (Radio Port) 104 to Switch/Router 102 may be cable. The connection from Switch/Router 102 to a trunk 208 may be either cable or wireless high gain antenna (WiFi or WiMax). trunk 208 may be either part of a Wireless City or an Operator.

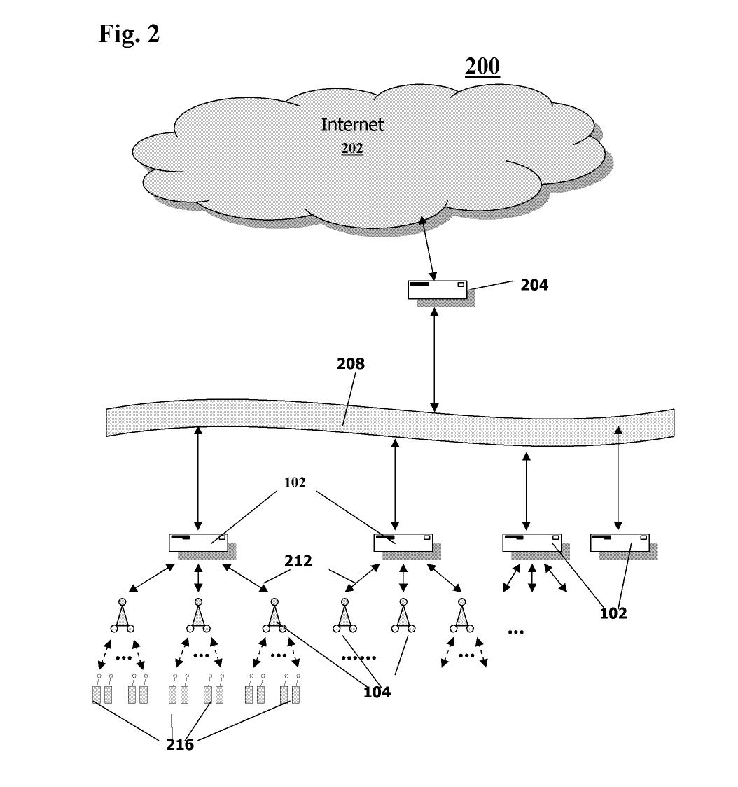

Referring specifically to FIG. 2, a high speed VoIP WiFi network hierarchy 200 is shown. A WAN (wide area network) such as Internet 202 provides the medium of communications to other devices suitable for coupling thereto. A Platform 204 is interposed between Internet 202 and trunk 208 interfacing there between. Platform 204 usually consists of a Gateway, a SIP (Session Initiation Protocol) server, a RADIUS (remote authentication dial in user service) and AAA (Authentication, Authorization and Accounting), etc. Trunk 208 in turn offers couplings to a plurality of switch/router 102. Each switch/router 102 is coupled to a plurality of RPs 104. RPs 104 provide wireless communications to at least one WiFi phone 216.

We now describe a high speed hand-over in WiFi base station 100. Two cases of hand-over will be described. In the first case 300, the hand-over is between the RPs 104, which are within the same base station 100. This is the case for; i.e. the walking speed, in that a user associated with 216 is moving around the same building or different floor level therein. The speed for first case 300 usually is less than 10 km/hr. The hand-over is handled mostly by or within the RP 104 itself, Switch/Router 102 is merely in a supporting mode.

In the second case 400, the hand-over is between the different base stations 100. Second case 400 is usually for a high speed mobility case. For example, a client or user is in a city bus or in driving a car. For second case 400, both RP 104 and Switch/Router 102 are actively involved.

The following are descriptions of the high speed hand-over process for a WiFi base station, and WiFi base stations.

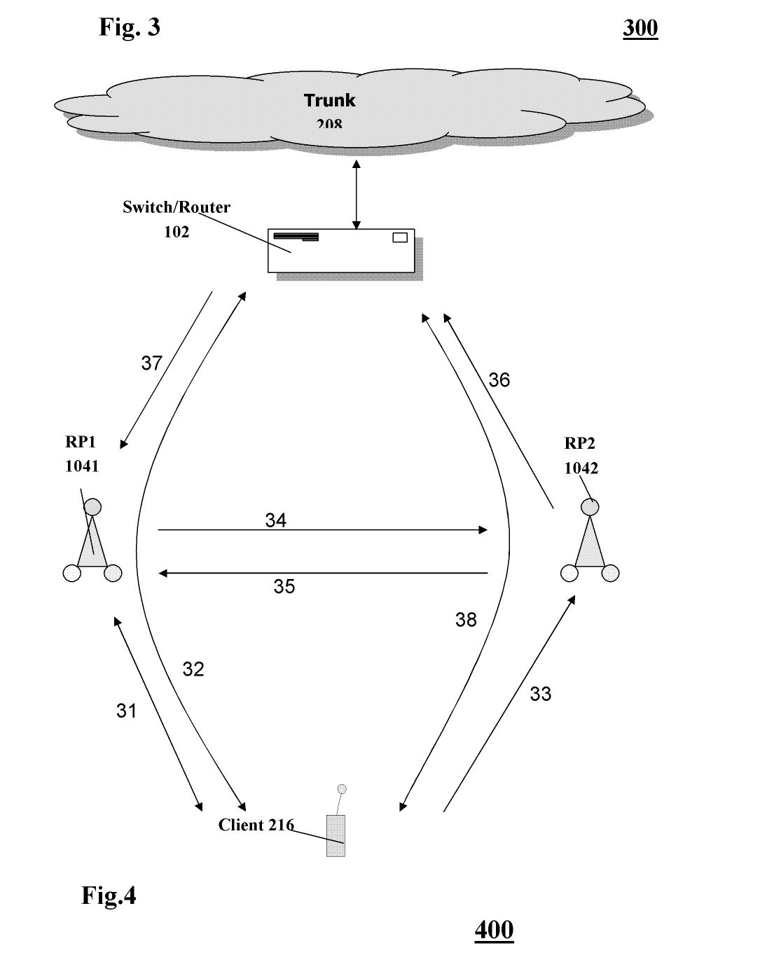

Referring specifically to FIG. 3, the hand-over of first case 300 between the RPs 104 within same base station 100 is described. The process starts with the normal flow in which RP1 1041 talks to client 216. At this juncture, RP2 1042 merely listens but is not talking to client 216. When Client 216 is moving, at client's TDM (time division multiplexing) slot, RP1 1041 talk is getting progressively weaker, and the signal at RP2 1042 which listens to is getting better. RP1 1041 requests RP2 to take-over and sends authentication to RP2 1042. In turn, RP2 1042 asks Switch/Router 102 to update routing table and acknowledges RP1 1041 to release. RP2 1042 handles client 216 at the next TDM slot. System goes back to normal flow again with RP2 1042 talking to 216 and other RPs 104 including RP1 1041 merely listening but is not talking to client 216. Switch/Router 102 is informationally coupled to trunk 208.

More detail description of hand-over in FIG. 3 is described as following. In the beginning of link, Client 216 and RP1 1041 have the mutual two way link as shown by arrow 31 to establish the linkage, for example, authentication and authorization processes. And then, the normal flow between Client 216 and Internet network is shown by arrow 32 from Client 216, passing through RP1 1041 to Switch/Router 102, and coupling to Trunk 208. At normal flow, RP2 1042 only listens to Client 216 as shown by arrow 33 which is an one way link. When Client 216 is moving, RP1 1041 talk is getting progressively weaker, RP1 1041 starts to sent out request to RP2 1042 for reporting its signal strength trend as shown by arrow 34. RP2 1042 answers to RP1 1041 by arrow 35 that his signal is getting better and then RP1 1041 requests RP2 1042 by arrow 34 again to take over and sends authentication to RP2 1042. In turn, RP2 1042 asks Switch/Router 102 by arrow 36 to update routing table and acknowledges RP1 1041 by arrow 37 to release. RP2 1042 then handles Client 216 shown by arrow 38. System goes back to normal flow again with RP2 1042 talking to Client 216 as shown by arrow 38.

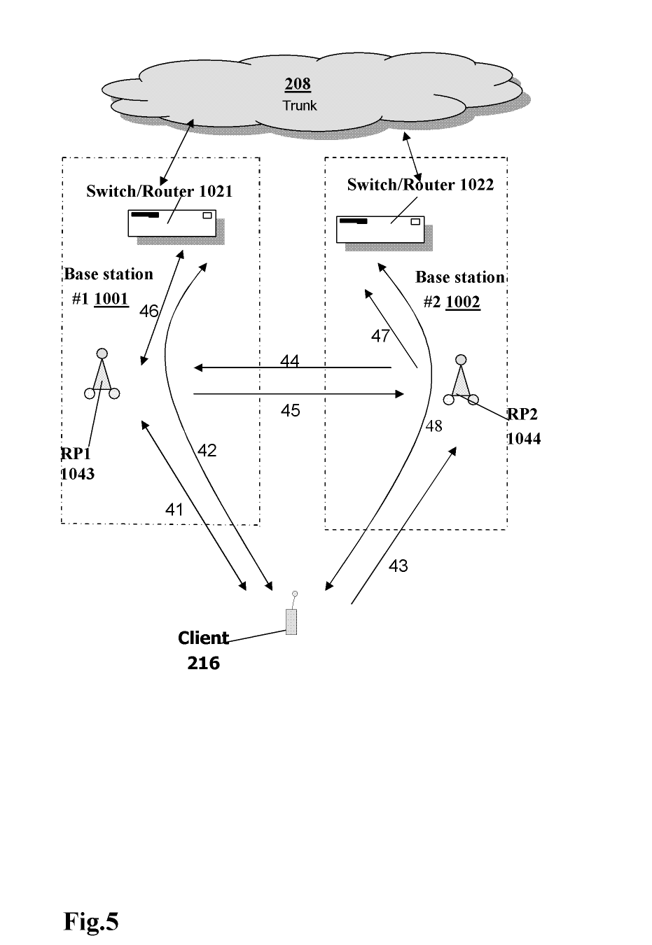

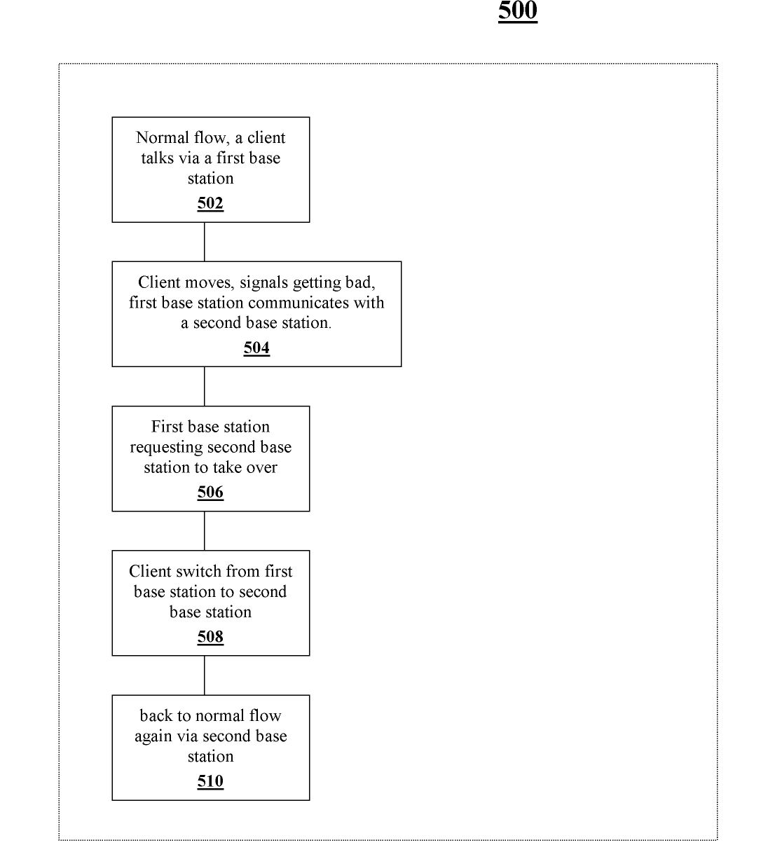

Referring specifically to FIG. 4, the hand-over of second case 400 between different base stations 100 is described. During normal flow, a RP 1043 in base station #1 1001 talks to client 216, RP 1044 in base station #2 1002 merely listens. When client 216 is moving, RP 1043 in base station #1 1001 talk is getting bad, RP 1044 in base station #2 1002 listens therefore and determines that signal quality therein is good Base station #1 1001 requests base station #2 1002 to take-over and pass authentication and authorization to base station #2 1002. RP 1044 in base station 2 1002 acknowledges RP 1043 in base station #1 1001 to release RP 1043 and talk to RP 1044. Therefore, RP 1044 in base station #2 1002 handles client 416. System goes back to normal flow again. As can be seen, the common features between case one 300 and case two 400 comprises no beacon waiting, fast authentication & authorization, and fast routing table updating. One the other hand, the differences between case one 300 and case two 400 comprises hand-over is mostly handled by Switch/Routers 102 in case two, and most hand-over is handled by RPs 104 in case one 300.

The detailed description of hand over in FIG. 4 is as followings.

During normal flow, Client 216 talks to RP1 1043 in base station #1 1001 through arrow 41 and then through arrow 42 connects to Switch/Router 1021 in base station #1 1001 and Trunk 208. RP2 1044 in base station #2 1002 merely listens through arrow 43. When Client 216 is moving, RP1 1043 in base station #1 1001 talk is getting bad or degraded. RP1 1043 sends request to neighboring base station through arrow 44 asking to report signal strength tend. RP2 1044 in base station #2 1002 reports to RP1 1043 in base station #2 1001 that its signal strength is good and getting stronger through arrow 45. RP1 1043 in base station #1 1001 reports to Switch/Router 1021 in base station #1 1001 through arrow 46 and prepare to transfer the flow to other base station. RP1 1043 in base station #1 1001 then requests base station #2 1002 to take over and passes authentication and authorization to base station #2 1002 through arrows 44 and 47 to their respective device. Switch/Router 1022 in base station #2 1002 starts to set up the new flow and then acknowledges base station #1 1001 to release RP1 1043 through arrow 44. Therefore, RP2 1044 in base station #2 1002 handles Client 416 through arrow 48. System goes back to normal flow again.

Referring to FIG. 5, a flowchart 500 of the present invention is shown. During normal flow (Step 502), a Client such as client 216 talks to a first RP such as RP1 1043 in a first base station such as base station #1 1001. A second RP such as RP2 1044 in base station #2 1002 merely listens. When Client is moving, the first RP in the first base station talk is getting bad or degraded. First RP sends request to neighboring base stations asking to report signal strength trend (Step 504). Second RP in second base station reports to the first RP in the first base station that its signal strength is good and getting stronger. In turn, first RP in the first base station reports to a Switch/Router such as Switch/Router 1021 in first base station and prepare to transfer the flow to other base stations. In turn, first RP requests second base station to take over and passes authentication and authorization to second base station to their respective device (Step 506). Switch/Router in second base station starts to set up a new flow and then acknowledges the first base station, and releases first RP. Second RP in second base station then handles Client. Client switch from first base station to second base station (Step 508). System goes back to normal flow again (Step 510).

Further, the switch-over time needs to be less than 0.5 second in the preferred embodiment in order to meet minimum 60 km hr mobile speed requirement.

Comparing the present invention's WiFi network with other wireless networks; e.g., cell phone network, the following differences exist: (1) In the WiFi network of the present invention, the client terminal and the base station are both active. There are a lot of applications for the present invention, for example, getting information or services through internet from various kinds of content providers using this WiFi network. The mobile capability is greatly improved in the present invention because the base station is no longer passive and is heavily involved in the mobility process. (2) In cell phone networks, for example, in 2 G or 2.5 G systems, the base station plays major role while the client terminal has very limited freedom to define the application. Although in cell phone systems, excellent mobility is provided because the base station can handle the mobility itself without the involvement of the client terminal but the system lacks the freedom of broad range of applications such as taught in the present invention. For 3 G case, in order to support multi-media application, the client terminal has a more active role to define their applications, but bandwidth and data cost are their major shortcomings.

This invention enhances the role of the WiFi base station to obtain the mobility which is not only for VoIP voice application but also for multi-media video application and also maintains the client terminal's freedom for defining their applications. This invention combines the advantages of WiFi network such as broadband, low cost and broad application and those of cell phone network such as mobility without suffering the shortcomings of both networks.

Furthermore, from the structure point of view, the base station in this invention is smaller in terms of physical size because of smaller coverage area and low power requirements resulting in significantly lowered costs comparing to those of cell phone base stations. The base station in this invention has significantly more functions than the regular cell phone base stations because this network will handle many more applications which connect to different content providers through the common public Internet network such as IP network while cell phone network has simpler situation because it is a private network.

In the present invention, a hand-over method is provided. The method comprises: providing a hand-over context; providing a switch/router; and providing at least one radio port. Whereby, the base station plays a significant role in the hand-over process.

A communications system is provided. The system comprises: a plurality of base stations. Each base station comprises: a switch/router; and at least one radio port. Whereby, the base stations play a significant role in a hand-over process.

A base station comprising a switch/router; and at least one radio port is provided. Whereby, the base station plays a significant role in a hand-over process.

The base station comprises a radio port cluster and a switch/router. Instead of passively following the order from a client terminal, the WiFi base station of the present invention plays the major role in a hand-over process. The base station will monitor the client terminal signal strength and negotiate with other base stations for the client terminal connection including authentication and authorization. When the client terminal's signal strength is changing, the base station will send out a request to other base stations to report signal strength and trend of this particular client terminal. Based on reported signal strength and trend, a determination is made as to which of the other base stations should take over the servicing of the client terminal. The authentication is then forwarded to this base station. The client terminal may not be aware of the hand-over activities.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A base station comprising:
a switch/router; and
at least one radio port;
whereby the base station playing a significant role in a hand-over process.

2. The base station of claim 1, wherein the base station is a WiFi base station.

3. The base station of claim 1, wherein the at least one radio port is associated with the switch/router.

4. The base station of claim 1, wherein the hand-over is mostly handled by the at least one radio port.

5. The base station of claim 1, wherein the at least one a radio port is associated with a second switch/router.

6. The base station of claim 1, wherein the hand-over is mostly handled by Switch/Routers.

7. A communications system comprising:
a plurality of base stations, each base station comprising:
a switch/router; and
at least one radio port;
whereby the base stations playing a significant role in a hand-over process.

8. The communications system of claim 7, wherein the base station is a WiFi base station.

9. The communications system of claim 7, wherein the at least one radio port is associated with the switch/router.

10. The communications system of claim 7, wherein the hand-over is mostly handled by the at least one radio port.

11. The communications system of claim 7, wherein the at least one a radio port is associated with a second switch/router.

12. The communications system of claim 7, wherein the hand-over is mostly handled by Switch/Routers.

13. A hand-over method comprising:
providing a hand-over context;
providing a switch/router; and
providing at least one radio port;
whereby the base station playing a significant role in a hand-over process.

14. The method of claim 13, wherein the base station is a WiFi base station.

15. The method of claim 13, wherein the at least one radio port is associated with the switch/router.

16. The method of claim 13, wherein the hand-over is mostly handled by the at least one radio port.

17. The method of claim 13, wherein the at least one a radio port is associated with a second switch/router.

18. The method of claim 13, wherein the hand-over is mostly handled by Switch/Routers.
